(19) United States
(12) Patent Application Publication
(10) Pub. No.: US 2014/0148215 A1
(43) Pub. Date: May 29, 2014

(54) MOBILE COMMUNICATION DEVICE CAPABLE OF SWITCHING BETWEEN DIFFERENT ANTENNA MODES

(71) Applicant: Hon Hai Precision Industry Co., Ltd., New Taipei (TW)

(72) Inventors: CHIEN-CHANG LIU, New Taipei (TW); YEN-HUI LIN, New Taipei (TW)

(73) Assignee: HON HAI PRECISION INDUSTRY CO., LTD., New Taipei (TW)

(21) Appl. No.: 14/038,784

(22) Filed: Sep. 27, 2013

(30) Foreign Application Priority Data
Nov. 29, 2012 (TW) 101144721

(51) Int. Cl. H04W 88/06

(52) U.S. Cl. CPC H04W 88/06
USPC 455/552.1

(57) ABSTRACT

A mobile communication device capable of switching antenna modes is provided. The device includes a body, a first antenna, a second antenna, a data transceiver unit, a voice transceiver unit, and an antenna switching unit. The first antenna is arranged on the top of the body and the second antenna is arranged on the bottom of the body. If the device is on a voice communication mode, the antenna switching unit connects the data transceiver unit to the first antenna, and connects the voice transceiver unit to the second antenna, in order to make the voice communication being smooth. If the device is on a data communication mode but not on the voice communication mode simultaneously, the antenna switching unit connects the data transceiver unit to the second antenna, and connects the voice transceiver unit to the first antenna, in order to improve the data transmission performance.

### BACKGROUND

1. Technical Field

The present disclosure relates to a mobile communication device capable of switching between different antenna modes.

2. Description of Related Art

Existing mobile telephones supporting SVLTE (Simultaneous Voice and LTE) function have both CDMA antenna and LTE antenna. The CDMA antenna for voice communication is usually arranged on the bottom of the telephone, and the LTE antenna for data communication is usually arranged on the top of the telephone. However, these antenna arrangements are beneficial for voice transmission, but are bad for data transmission. That is because a lot of electronic components are provided in the internal of the telephone, and a house for housing a battery is defined in the lower portion of the telephone, so, few of the electronic components are arranged on the lower portion of the telephone, and will bring less interference to the performance of the CDMA antenna; most of the electronic components are arranged on the upper portion, and will bring more interference to the performance of the LTE antenna. That is why users usually suffer trouble with data transmission, and these troubles are presented more obvious in use of cloud network technology.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a mobile communication device, according to an embodiment.

FIG. 2 is a block diagram of the mobile communication device of FIG. 1. The mobile communication device includes an antenna switching unit.

FIG. 3 is a schematic diagram illustrating relationship between different communication modes and the antenna switching unit of the mobile communication device of FIG. 2.

FIG. 4 is a structure diagram of the mobile communication device of FIG. 2, when the antenna switching unit is in a first conducting state.

FIG. 5 is a structure diagram of the mobile communication device of FIG. 2, when the antenna switching unit is in a second conducting state.

### DETAILED DESCRIPTION

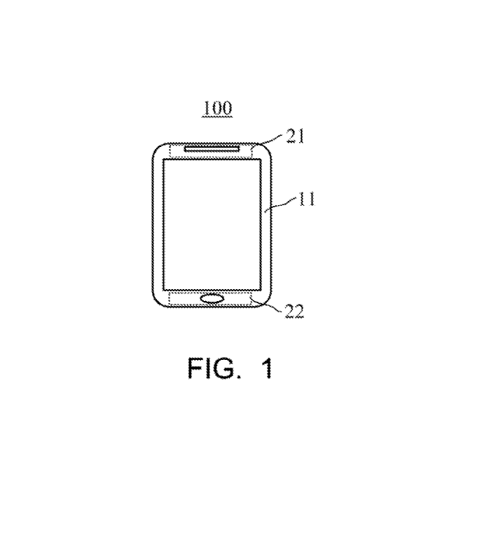

FIG. 1 shows a mobile communication device 100 of the embodiment. The mobile communication device 100 includes a body 11, and a first antenna 21 and a second antenna 22 arranged in the body 11. In the embodiment, the first antenna 21 is arranged on the top of the body 11, and the second antenna 22 is arranged on the bottom of the body 11.

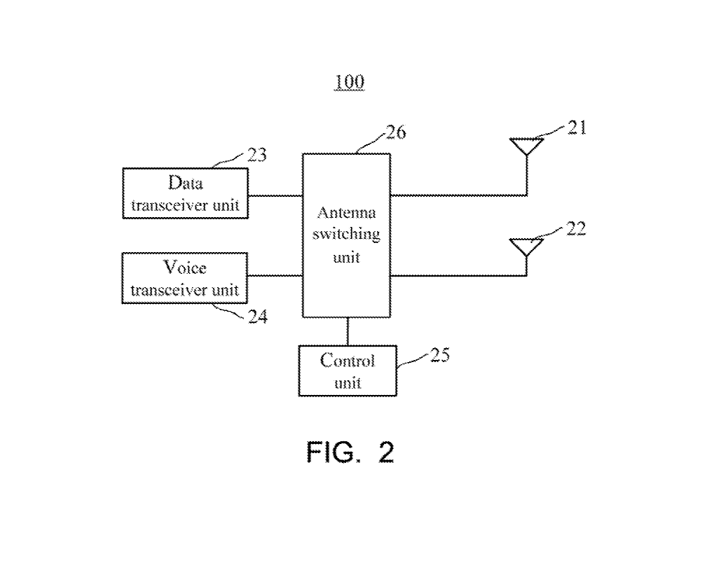

FIG. 2 shows that the mobile communication device 100 further includes a data transceiver unit 23, a voice transceiver unit 24, a control unit 25 and an antenna switching unit 26. The control unit 25 is electrically connected to the antenna switching unit 26, and is configured to output control signals to enable the antenna switching unit 26 to be on different conducting states, according to communication mode which the mobile communication device 100 is on. In the embodiment, the communication modes of the mobile communication device 100 include a voice communication mode, a data communication mode, and an idle mode, for example.

The antenna switching unit 26 is connected between the first antenna 21 and the second antenna 22, and between the data transceiver unit 23 and the voice transceiver unit 24. The antenna switching unit 26 is configured to selectively connect one data transceiver unit 23 and the voice transceiver unit 24 to the first antenna 21, and selectively connect the other data transceiver unit 23 and the voice transceiver unit 24 to the second antenna 22, in response to the control signals output from the control unit 25.

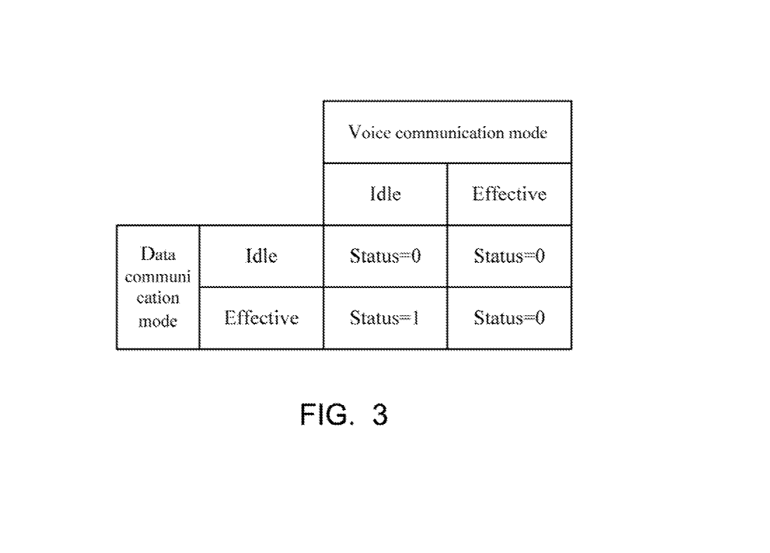

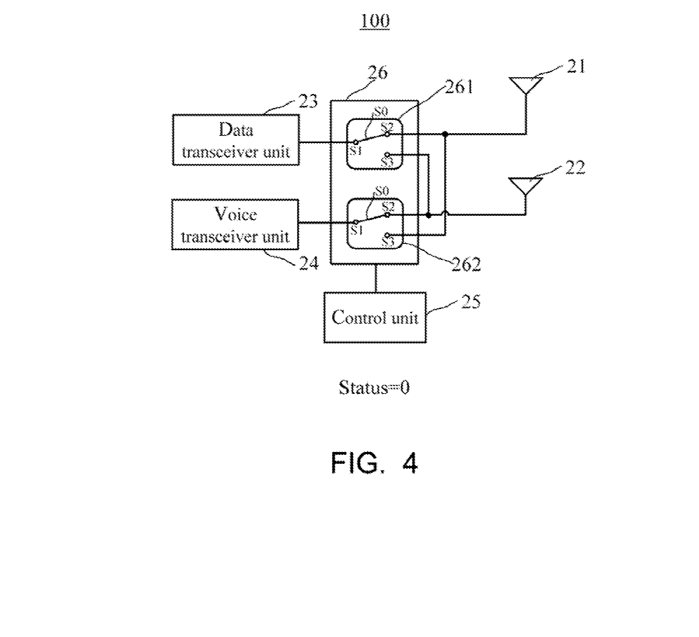

FIGS. 3 and 4 shows that if the mobile communication device 100 is on the voice communication mode, the control unit 25 outputs a first control signal to enable the antenna switching unit 26 to be in a first conducting state, that is Status=0, in which the antenna switching unit 26 connects the data transceiver unit 23 to the first antenna 21, and connects the voice transceiver unit 24 to the second antenna 22, in order to make the voice communication being smooth.

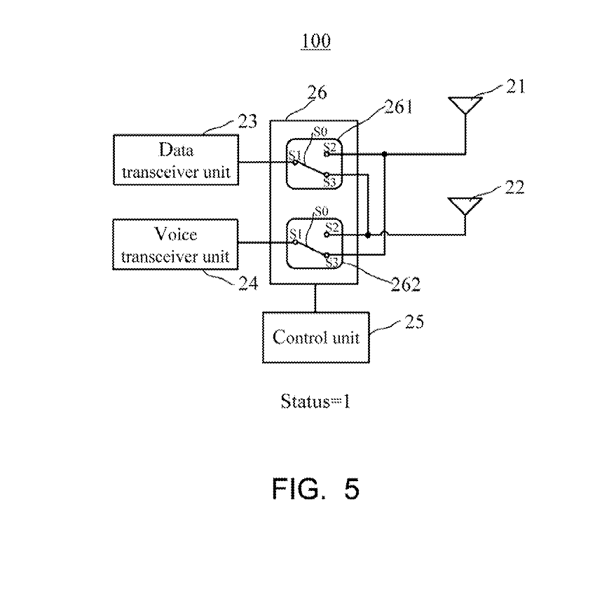

FIGS. 3 and 5 show that if the mobile communication device 100 is on the data communication mode but not on the voice communication mode simultaneously, the control unit 25 outputs a second control signal to enable the antenna switching unit 26 to be in a second conducting state, that is Status=1, in which the antenna switching unit 26 connects the data transceiver unit 23 to the second antenna 22, and connects the voice transceiver unit 24 to the first antenna 21, in order to improve the data transmission performance.

In order to ensure the voice communication is smooth at all times, if the mobile communication device 100 is on the data communication mode and the voice communication mode simultaneously, the control unit 25 outputs the first control signal to enable the antenna switching unit 26 to be in the first conducting state. That is Status=0. If the mobile communication device 100 is on the idle mode, that is no voice communication or data transmission, the control unit 25 also outputs the first control signal to enable the antenna switching unit 26 to be in the first conducting state.

FIGS. 4 and 5 show that in the embodiment, the antenna switching unit 26 includes a first switching unit 261 and a second switching unit 262. The first switching unit 261 is configured to selectively connect the data transceiver unit 23 to the first antenna 21 or the second antenna 22, and the second switching unit 262 is configured to selectively connect the voice transceiver unit 24 to the second antenna 22 or the first antenna 21.

In this embodiment, both of the first switching unit 261 and the second switching unit 262 are a single-pole double-throw (SPDT) switch, and each of them includes a first contact point S1, a second contact point S2, a third contact point S3, and a contact arm S0 having one end connected to the first contact point S1. In the embodiment, the first contact point S1 of the first switching unit 261 is connected to the data transceiver unit 23. The first contact point S1 of the second switching unit 262 is connected to the voice transceiver unit 24. The second contact point S2 of the first switching unit 261 and the third contact point S3 of the second switching unit 262 are both connected to the first antenna 21. In addition the third contact point S3 of the first switching unit 261 and the second contact point S2 of the second switching unit 262 are both connected to the second antenna 22.

If the antenna switching unit 26 is enabled to be in the first conducting state, that is Status=0, an other end of the contact arm S0 of the first switching unit 261 is connected to the second contact point S2, to connect the data transceiver unit 23 to the first antenna 21; correspondingly, an other end of the contact arm S0 of the second switching unit 262 is connected to the second contact point S2, to connect the voice transceiver unit 24 to the second antenna 22.

If the antenna switching unit 26 is enabled to be in the second conducting state, that is Status=1, the other end of the contact arm S0 of the first switching unit 261 is connected to the third contact point S3, to connect the data transceiver unit 23 to the second antenna 22; the other end of the contact arm S0 of the second switching unit 262 is connected to the third contact point S2, to connect the voice transceiver unit 24 to the first antenna 21.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A mobile communication device capable of switching between different antenna modes, the mobile communication device comprising:
a body;
a first antenna and a second antenna arranged in the body, wherein the first antenna is arranged on the top of the body, and the second antenna is arranged on the bottom of the body;
a data transceiver unit and a voice transceiver unit;
an antenna switching unit connected between the first antenna and the second antenna, and between the data transceiver unit and the voice transceiver unit; and
a control unit electrically connected to the antenna switching unit;
wherein, if the mobile communication device is on a voice communication mode, the control unit outputs a first control signal to enable the antenna switching unit to be in a first conducting state, in which the antenna switching unit connects the data transceiver unit to the first antenna, and connects the voice transceiver unit to the second antenna;
if the mobile communication device is on a data communication mode but not on the voice communication mode simultaneously, the control unit outputs a second control signal to enable the antenna switching unit to be in a second conducting state, in which the antenna switching unit connects the data transceiver unit to the second antenna, and connects the voice transceiver unit to the first antenna.

2. The mobile communication device as described in claim 1, wherein the antenna switching unit includes a first switching unit and a second switching unit, wherein the first switching unit is configured to selectively connect the data transceiver unit to the first antenna or the second antenna, and the second switching unit is configured to selectively connect the voice transceiver unit to the second antenna or the first antenna.

3. The mobile communication device as described in claim 2, wherein each of the first switching unit and the second switching unit comprises a first contact point, a second contact point, a third contact point, and a contact arm having one end connected to the first contact point; wherein the first contact point of the first switching unit is connected to the data transceiver unit, the first contact point of the second switching unit is connected to the voice transceiver unit, the second contact point of the first switching unit and the third contact point of the second switching unit are both connected to the first antenna, and the third contact point of the first switching unit and the second contact point of the second switching unit are both connected to the second antenna.

4. The mobile communication device as described in claim 3, wherein if the antenna switching unit is enabled to be in the first conducting state, an other end of the contact arm of the first switching unit is connected to the second contact point, to connect the data transceiver unit to the first antenna; an other end of the contact arm of the second switching unit is connected to the second contact point, to connect the voice transceiver unit to the second antenna.

5. The mobile communication device as described in claim 3, wherein if the antenna switching unit is enabled to be in the second conducting state, an other end of the contact arm of the first switching unit is connected to the third contact point, to connect the data transceiver unit to the second antenna; an other end of the contact arm of the second switching unit is connected to the third contact point, to connect the voice transceiver unit to the first antenna.

6. The mobile communication device as described in claim 1, wherein if the mobile communication device is on the data communication mode and the voice communication mode simultaneously, the control unit outputs the first control signal to enable the antenna switching unit to be in the first conducting state.

7. The mobile communication device as described in claim 1, wherein if the mobile communication device is on an idle mode, the control unit outputs the first control signal to enable the antenna switching unit to be in the first conducting state.
